(19) United States
(12) Patent Application Publication
(10) Pub. No.: US 2021/0156155 A1
(43) Pub. Date: May 27, 2021

(54) AUTOMATED DEVICE FOR CONSTRUCTION PANELS

(71) Applicant: SAINT-GOBAIN PLACO, Courbevoie (FR)

(72) Inventors: Pierre LOMBARD, AUBERVILLIERS (FR); Stéphanie PELLETIER, AUBERVILLIERS (FR); Daniel MELICE, AUBERVILLIERS (FR)

(21) Appl. No.: 17/044,926

(22) PCT Filed: Apr. 3, 2019
(86) PCT No.: PCT/FR2019/050781

§ 371 Date: Oct. 2, 2020

(30) Foreign Application Priority Data
Apr. 4, 2018 (FR) 1852936
Apr. 4, 2018 (FR) 1852939

(51) Int. Cl. E04F 21/18; B62D 57/024; E04F 21/16

(52) U.S. Cl. CPC E04F 21/1838; E04F 21/16; B62D 57/024

(57) ABSTRACT

An automated device designed to move bearing against a construction panel, includes a frame carrying a tool designed to perform at least one mechanical operation on the construction panel, the automated device including at least one suction body designed to hold the automated device against the construction panel, and at least one system for initiating the movement of the automated device along the construction panel. The automated device includes at least one control unit designed to control at least the system for initiating the movement of the automated device according to at least one item of data relating to the position of a support of the construction panel.

The field of the present invention is that of construction panels used in the building sector. The present invention is applied particularly advantageously, but not exclusively, to construction panels referred to as plasterboard sheets, which are formed from a layer of plaster inserted between two facing sheets, generally made of cardboard.

Construction panels are widely employed in the building industry for example for creating partitions, flooring or ceilings, to cover such surfaces, to thermally and/or acoustically insulate them, to protect these surfaces from moisture, or to line these surfaces. Construction panels correspond to sheets made from a material chosen depending on its use. By way of indication, construction panels comprising plaster, wood or wood chips, synthetic materials, mixed fibers, mineral particles, or a mixture of these materials may be mentioned, these construction panels also being able to be covered with a surface coating made of a material different than the chosen material.

A framework serves as a support for the fastening of such construction panels to room walls and ceilings. This makes it necessary to carry out several successive fastening operations using fastening means. These fastening operations ensure that each construction panel is secured to the framework. For optimum fastening, twelve screws per square meter of construction panel are necessary on average. Thus, it will be understood that, in order to create an entire partition, this step of fastening the construction panels is particularly time-consuming for the worker charged with carrying out this operation. This represents a first drawback of the currently known art.

Moreover, the fastening tools normally used are often heavy, adding an additional constraint for the worker. The fastening step can then become particularly difficult, in particular when it is a matter of fastening a construction panel to a ceiling or when it is a matter of fastening an upper part of the construction panel situated above the worker charged with carrying out the operation. This represents a second drawback.

The aim of the invention is to overcome these various drawbacks.

To this end, a subject of the invention is an automated device configured to move in abutment against a construction panel, the automated device comprising a carrying frame for a tool configured to carry out at least one mechanical operation on the construction panel, the automated device comprising at least one suction member configured to hold the automated device against the construction panel and at least one means for setting the automated device in motion along the construction panel, wherein the automated device comprises at least one control unit configured to control at least the means for setting the automated device in motion depending on at least one item of data relating to the position of the support of the construction panel.

More particularly, the mechanical operation carried out on the construction panel is chosen from an operation of fastening the construction panel to the support, an operation of cutting the construction panel or an operation of sanding the construction panel.

The present invention therefore aims to respond to the constraints set out above by proposing a reliable automated device that is capable of moving easily on the construction panel, carrying out the mechanical operations normally intended to be carried out by the drywall worker. Such an automated device according to the invention makes it possible to carry out these mechanical operations repeatedly on a construction panel covering a room wall, a ceiling or a floor in complete safety. Such an automated device is suited to the constraints of adhesion and friction that are inherent to any inclination of the surface over which it moves.

The construction panels to which the automated device according to the invention applies are panels used for example to entirely or partially cover a wall of a building or to create a partition distinct from a wall, in particular room partitioning. The term building should be understood broadly here and can denote, in the following text, either an entire construction, a room or a set of rooms of a construction. The construction panels at which the invention is aimed can be of various kinds and dimensions: by way of nonlimiting examples, they may be plasterboard sheets, wood panels or panels made from a composite material based for example on wood fragments. Regardless of their kind, they are in the overall form of a rectangular parallelepiped with a small thickness. In other words, these construction panels have two main faces that are substantially flat and rectangular, to within manufacturing tolerances, and are separated from one another by a thickness, the dimension of which is small with respect to the length and the width of the abovementioned main faces.

Regardless of their kind, the construction panels to which the automated device according to the invention applies are intended to be fastened to a support that is itself either freestanding, in particular in the case of room partitioning, or secured to the wall in question, being disposed for example parallel to this wall, in direct contact therewith or at a distance therefrom. Such a wall may be, in a nonlimiting manner, a floor, a room wall or a ceiling of a room of this building. With reference to a trihedron L, V, T defined by the conventional spatial orientations horizontal, vertical and transverse, respectively, the abovementioned wall can thus be positioned horizontally (in the case in which the wall in question is a floor or a ceiling), vertically (in the case in which the wall in question is a room wall), or in any combination of these orientations. Furthermore, the wall in question may be either an interior wall or an exterior wall of the building.

The movement of the automated device according to the invention in abutment against the construction panel should be understood here as meaning that, as it moves against a surface of the construction panel, the automated device remains in permanent contact with this surface, regardless of the spatial orientation of the construction panel, specifically without the need for an exterior mechanical holding device. In other words, the mechanical holding of the automated device according to the invention in permanent contact with the surface of the construction panel against which it moves is effected autonomously by the automated device that is the subject of the invention.

For this purpose, the automated device according to the invention comprises at least one suction member. Advantageously, the suction member comprises at least one sealing device and a constituent plate of the frame, which delimit a vacuum chamber. Once pressed against the construction panel, the vacuum chamber is closed by the face of this panel. At the other end of the vacuum chamber, the latter is terminated by a pressure reducing means that the suction member comprises, such a means being for example an impeller.

For its part, the sealing device is configured to be involved simultaneously in a pressure reduction effected by the suction member and in setting of the automated device according to the invention in motion. In other words, the suction member is configured to keep the automated device according to the invention pressed against the surface of the construction panel against which it is placed, including while said automated device is moving.

According to various embodiments, the abovementioned sealing device may comprise, in a nonlimiting manner, a seal covered with a film of a material chosen for its mechanical properties in terms of friction, or treated so as to have mechanical properties, in particular in terms of friction, making it possible to combine the maintenance of the abovementioned pressure reduction and the movement of the automated device according to the invention. According to other embodiments, the seal itself may be made of such a material, for example of a fluoropolymer material such as the one known under the trade name Teflon®.

In the automated device according to the invention, the suction member and the means for setting in motion along the construction panel are therefore configured to act simultaneously so as to ensure permanent contact between the construction panel and the automated device, including while the latter is moving.

The mechanical operation carried out by means of the tool with which the automated device according to the invention is equipped may be, by way of nonlimiting examples, an operation of fastening the construction panel to the support, an operation of cutting the construction panel or an operation of sanding the construction panel.

The operation of fastening the construction panel to the support comprises screwing a screw through the construction panel and into engagement with the support so as to press this construction panel against the support. Such a fastening operation may also comprise nailing or stapling of the construction panel to the support.

The operation of cutting the construction panel comprises closed-perimeter cutting, for example cutting effected with a hole saw for the passage of one or more cables, or cutting of a large opening. In both cases, it is advantageous to know the location of the support either to avoid interfering with this support or to adapt the cutting tool to the material of this support.

The operation of sanding the construction panel comprises the sanding of a coating which is in particular spread so as to cover a strip that joins two sheets. This junction between two sheets is realized at a support and the detection of the latter consequently makes it possible to determine the position of regions to be sanded. The same goes for the coating applied so as to cover a screw head.

In the following text, the invention will be described preferably in the context of an operation of fastening the construction panel to a support, but it extends to any mechanical operation on the construction panel in which it is appropriate to know the position of the support before carrying out the mechanical operation.

A support is understood to be any rigid element or set of rigid elements that form all or part of a framework suitable for receiving one or more construction panels. The framework may be freestanding, in that construction panels can be for example fastened on either side of such a framework to form room partitioning, or disposed parallel to an existing wall. In the latter case, the support can be fastened to the existing wall by means of screws or adhesive bonding. The support can also be attached at a distance from the wall and held in position, for example, by means of spacer devices fastened to the wall. In a nonlimiting manner, the support can be made of metal, wood, or from a composite material for example based on wood fragments.

According to one aspect of the invention, the control unit is configured to communicate with a system for identifying the position of the support.

Advantageously, the automated device comprises the identification system. In other words, the identification system is installed on the automated device. The control unit thus controls the means for setting the automated device in motion on the basis of an item of data relating to the support position identified or detected by way of technical means present on the automated device.

Alternatively, the identification system is remote from the automated device. In the latter case, the control unit controls the means for setting the automated device in motion depending on one or more items of information that indicate a position of the support and originate from a device external to the automated device.

The invention also envisions configuring the control unit to communicate both with an identification system installed on the automated device and/or with an identification system remote from the automated device.

According to one example, with the automated device according to the invention moving over a surface of the construction panel, the identification system is configured such that the automated device according to the invention identifies or determines the position of a support of this construction panel.

According to an embodiment variant of the automated device according to the invention, the identification system comprises at least one sensor configured to detect a material forming the support. Advantageously, this sensor is configured to send to the control unit a signal representative of the presence of the support or of a material forming the support. Depending on the different types of material that can make up the support to which the construction panel is fastened, the identification system may comprise one or more of the following sensors:
a metal sensor, for detecting metallic supports. Such a sensor may be, for example, a sensor that works on the principle of magnetic induction,
a sensor for sensing the density of the material forming the support, used more particularly for detecting supports containing wood,
a sensor of the magnetometer type, for example with three axes, for detecting supports containing a metal,
an ultrasonic sensor.

According to another embodiment variant, the automated device according to the invention comprises a memory unit for storing a set of positions of the support. These data relating to the position of the support may take the form of coordinates or the form of a map of the support with respect to a predefined reference system.

According to one exemplary embodiment, the memory unit may be part of the identification system, whether the latter is installed on the automated device of the invention or remote from this automated device.

Advantageously, the control unit may comprise the memory unit.

Advantageously, the automated device according to the invention may comprise a control module configured to compare an instantaneous position of the automated device on the construction panel with at least one position of the support stored in the memory unit. According to various, non-exhaustive embodiments:
an initial position of the automated device on the construction panel may be determined manually by pre-positioning the automated device according to the invention at a reference point on the construction panel that is recorded as an initial position in the memory unit,
the position of the automated device according to the invention on the construction panel may be defined by a specific member for locating the position of the automated device according to the invention on the construction panel, for example calibrated to recognize a position of the automated device according to the invention with respect to one or more edges of the construction panel or with respect to one or more locators defined on the wall intended to receive the construction panel.

The device according to the invention is automated, meaning that the control unit is configured to bring about the operation of the various elements of which it is made up. In particular, the control unit is configured to control the means for setting the automated device in motion. In a complementary manner, this control unit is also configured to control the tool. In a complementary or alternative manner, the control unit is configured to control the suction member.

This control unit thus controls the operation of a motor that is capable of setting the device according to the invention in motion, for example an electric motor supplied with current by a domestic power supply or by an electrical storage device installed on the frame. To this end, the frame of the automated device according to the invention advantageously has one or more movement means, for example wheels, crawlers or legs, and a device for driving a wheel, a crawler or legs. The control unit also controls the operation of the suction member(s) and determines the autonomous retention of the automated device on the construction panel. Finally, the control unit controls the starting and stopping of the tool, on the basis of the information that it receives indicating the presence of the support.

The invention also covers an assembly comprising an automated device as described in the present document and an identification system remote from the automated device, the control unit of the automated device communicating with the identification system to receive the item of data relating to the position of a support of the construction panel.

The invention also extends to a method for using an automated device as has just been described to carry out a mechanical operation on a construction panel, the method according to the invention comprising at least:
a step of moving the automated device,
a step of identifying a support of the construction panel,
a step of employing the tool configured to carry out the mechanical operation desired.

According to one aspect of the invention, the mechanical operation is an operation of fastening the construction panel to the support, an operation of cutting the construction panel or an operation of sanding the construction panel.

According to different variants, the method according to the invention may comprise a step of detecting a material of which the support is made, or a step of comparing an instantaneous position of the automated device according to the invention on the construction panel with a set of received or prerecorded positions of the support, stored in a memory unit for storing data relating to positions of the support, as mentioned above.

In any event, the automated device according to the invention and the associated method achieve the aims set for the invention. Specifically, for example in the context of an application to the installation of a construction panel by screwing it to a support, the automated device according to the invention, by virtue of its intrinsic features and through the implementation of the associated method, autonomously carries out the repeated tasks of fitting the screws for fastening the construction panel to its support, at predefined spacings. Through the configuration of the mechanical tool that it bears, the automated device according to the invention reduces the difficulty caused by the various mechanical operations when they are repeated manually by construction workers.

The automated device is configured to move in abutment against a construction panel, and comprises a frame to which are fastened at least one means for setting the automated device in motion along the construction panel, a suction member configured to make it possible to hold the automated device against the construction panel, and a fastening tool configured to employ fastening means.

It will be noted here that the automated device described in the previous paragraph is also suitable for any tool that is capable of carrying out a mechanical operation on the construction panel. The fastening tool configured to employ fastening means can thus be replaced by a tool for cutting the construction panel or a tool for sanding the construction panel. The description of the features that are set out below relates to a fastening tool, but it will be understood that these features can be combined in a tool that carries out a mechanical operation on the construction panel, for example a cutting tool or a sanding tool.

In other words, one aspect of the present invention relates to a robot or automaton that comprises at least one locomotion member that allows it to move in abutment against a construction panel, and a fastening tool that allows it to fasten this construction panel. The construction panel thus forms a surface for the automated device to work and move on.

The construction panel is made of a mineral, natural or synthetic material, or of a combination of these materials. Advantageously, the construction panel contains at least plaster.

According to one aspect of the invention, the robot comprises at least one suction member that allows it to remain in abutment against this construction panel, regardless of the inclination of the latter. In other words, this construction panel may be for example flooring, a room wall or a ceiling.

Advantageously, the automated device according to the invention may comprise at least two suction members. According to one particular configuration, these suction members are then arranged on either side of the fastening tool. Advantageously, this configuration makes it possible to improve the stability of the automated device, in particular when the fastening tool employs the fastening means.

According to one feature, at least one suction member comprises at least one sealing device that delimits, with a plate, at least one chamber, the suction member comprising at least one means for reducing the pressure in this chamber, the automated device comprising at least one motor configured to activate the pressure reducing means. It will thus be understood that the means for reducing the pressure in the chamber is configured to draw out the air present in this chamber, between the automated device and the construction panel. The vacuum thus generated in the chamber is sufficient to allow the automated device to be held in abutment against the construction panel regardless of the position of the latter and regardless of the work step of the automated device.

Advantageously, the pressure reduction in the chamber is also determined so as to counteract a force generated by the fastening tool when the latter employs the fastening means.

Advantageously, when the automated device comprises two suction members, the latter are identical.

When the automated device comprises two suction members, the motor can be configured to simultaneously control each of the two pressure reducing means. Alternatively, provision could be made for each pressure reducing means to be controlled by its own motor. For example, this/these motor(s) are electric motors.

According to one variant, each suction member may comprise a plurality of sealing devices that delimit a plurality of chambers in which identical or different levels of reduced pressure can be generated, each suction member then also being able to comprise a plurality of pressure reducing means.

According to one feature, the fastening tool comprises a system for loading the fastening means. Advantageously, this system for loading the fastening means may be an automatic loading system. In other words, the fastening tool is configured to automatically load a fastening means in the fastening tool after the previous fastening means has been positioned. Optionally, the automated device according to the invention may also comprise a reserve of fastening means. The automatic loading system is then configured to take the fastening means directly from this reserve. Thus, this reserve is filled with as many fastening means as necessary so that the operator using the automated device no longer has to do anything once the automated device is in operation.

The fastening means employed by the automated device is for example a screw, a nail or a staple.

According to a first exemplary embodiment, the fastening tool comprises a screwdriver. According to this exemplary embodiment, it will be understood that the fastening means employed by this fastening tool are screws.

According to a second exemplary embodiment, the fastening tool comprises a nail gun. In other words, according to this second exemplary embodiment, the fastening means employed by the fastening tool are nails.

According to a third exemplary embodiment, the fastening tool comprises a stapler. In other words, according to this third exemplary embodiment, the fastening means employed by the fastening tool are staples.

According to one feature, the means for setting in motion comprises at least one wheel and an electric motor for driving the wheel, this wheel being configured to come into abutment against the construction panel. According to this feature, this at least one wheel is in contact with the construction panel and allows the automated device to move. Specifically, as mentioned above, this automated device is held in abutment on the construction panel by the suction member(s). Advantageously, the automated device comprises at least four wheels distributed in pairs close to the suction members. In other words, each suction member is arranged between two wheels. Even more advantageously, these wheels may be textured such that their grip on the construction panel is improved, thereby enhancing their traction capacity for the automated device. It will be understood that these textured wheels exhibit a significant advantage when the construction panel in question is a room wall or a ceiling.

According to one example, each wheel is controlled by a dedicated motor. This or these motor(s) is/are for example electric motors.

According to one exemplary embodiment, the automated device is powered by an energy source external to the automated device. According to another embodiment, the automated device is powered by an energy source internal to this automated device. A “source internal to the automated device” is understood to be a source installed on the frame, that is to say an energy source secured to this frame. For example, this internal source may be an electrical storage device.

It will thus be understood that, according to the first embodiment, the movements of the automated device are only limited by the presence of an electric wire necessary for connecting the automated device to the external energy source, whatever that is. It will also be understood that, according to the other embodiment, the movements of the automated device are only limited by the storage capacity of the electrical storage device.

The frame of the automated device comprises at least two lateral platforms, each carrying a suction member, the lateral platforms being connected together by at least one reinforcement and the fastening tool being positioned between these two lateral platforms. According to one feature, at least one of these lateral platforms comprises a deformable material that forms the plate that helps to delimit the chamber of the suction member carried by the lateral platform in question. Advantageously, the plates of each of the lateral platforms are formed by this deformable material. Thus, when the automated device is in abutment against the construction panel, these plates are configured to deform such that they come into abutment against the construction panel. Advantageously, this abutment makes it possible to further stabilize the automated device and thus to improve the precision with which the fastening tool employs the fastening means. For example, at least one plate, and advantageously both plates, is/are formed by a thin wooden board. A “thin wooden board” is understood to be a board with an average thickness of about 3 mm, this thickness being measured between two opposite faces of this board.

According to one application example, the construction panel is a plasterboard sheet. According to this application example, the fastening tool is then configured to fasten this plasterboard sheet to a framework, also known as a support. This framework may for example take the form of a plurality of rails connected together by one or more uprights, these rails and these uprights advantageously being made of metal or wood. It will be understood that the fastening tool, and also the fastening means employed by the fastening tool, are thus adapted to the materials used both for the construction panel and for the framework to which this construction panel is fastened.

Finally, the present description relates to a method for fastening a construction panel by means of an automated device as set out above, comprising at least one step in which a plurality of fastening points are defined, a step in which the automated device is positioned against the construction panel to be fastened, a step in which the suction member is activated so as to hold the automated device in abutment against the construction panel, a step in which the means for setting in motion is actuated such that the automated device moves to one of the fastening points, and a step in which the fastening tool employs a fastening means so as to fasten the construction panel.

It will be understood that the last two steps are repeated until fastening means have been positioned at each fastening point defined above.

Further features, details and advantages of the invention will become more clearly apparent from reading the description given below by way of indication, with reference to the following drawings, in which:

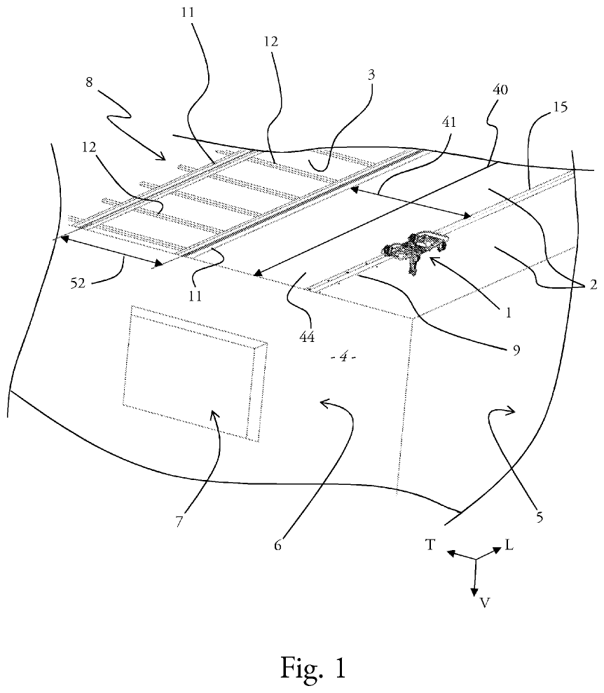

FIG. 1 schematically illustrates an automated device according to the invention in use against a ceiling;

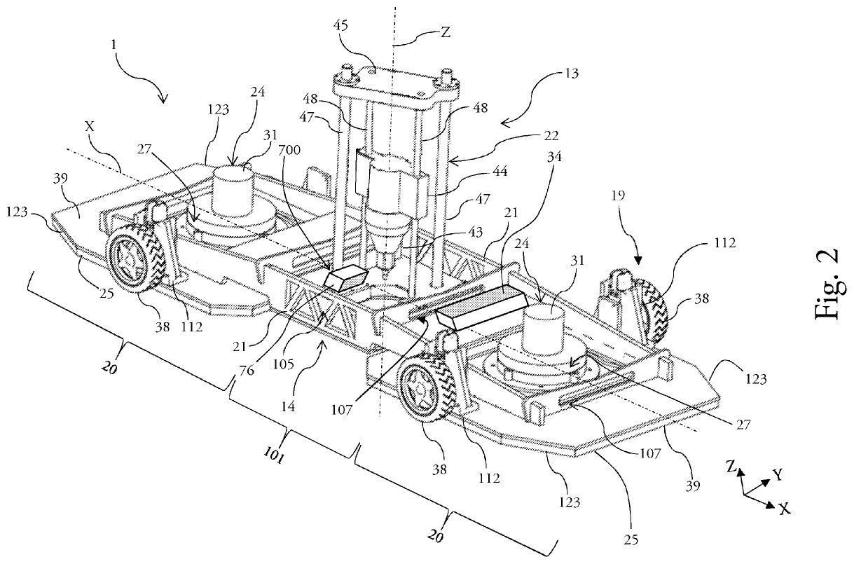

FIG. 2 is a schematic perspective view of an automated device according to the invention;

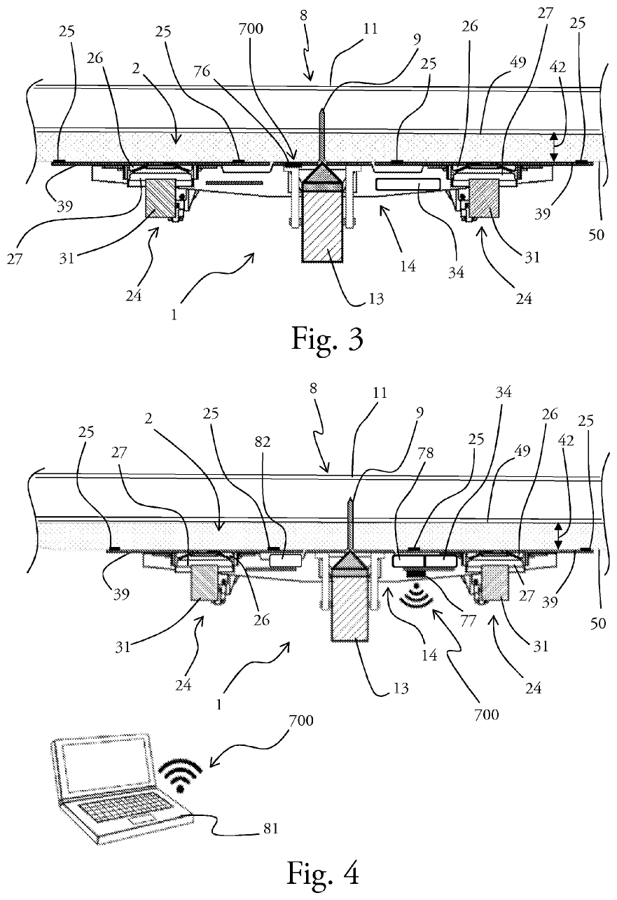

FIG. 3 is a schematic view in cross section of a construction panel on which a device according to a first embodiment variant of the invention has been placed;

FIG. 4 is a schematic view in cross section of a construction panel on which a device according to a second embodiment variant of the invention has been placed;

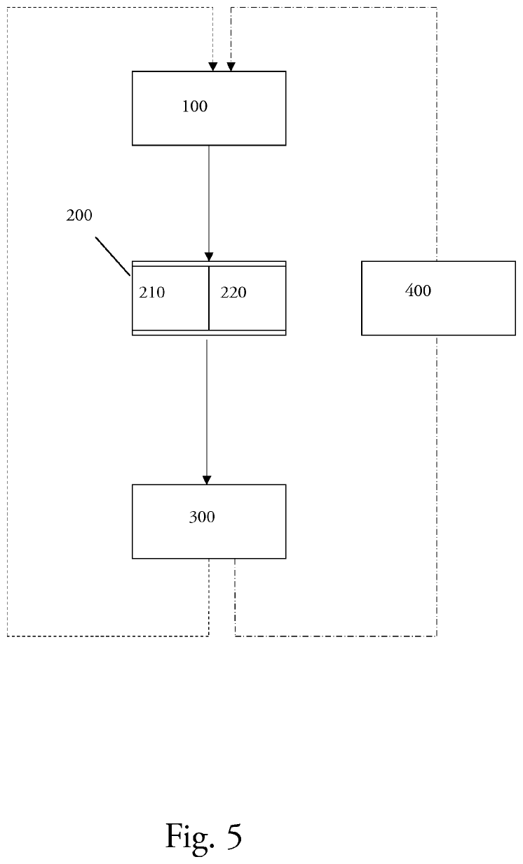

FIG. 5 is a schematic view of the different steps of a method according to the invention;

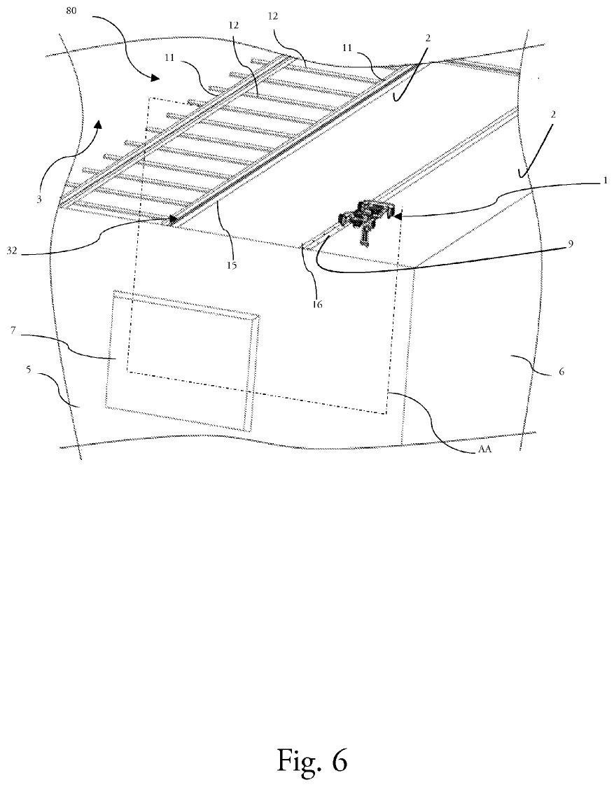

FIG. 6 schematically illustrates another example of an automated device in use against a ceiling;

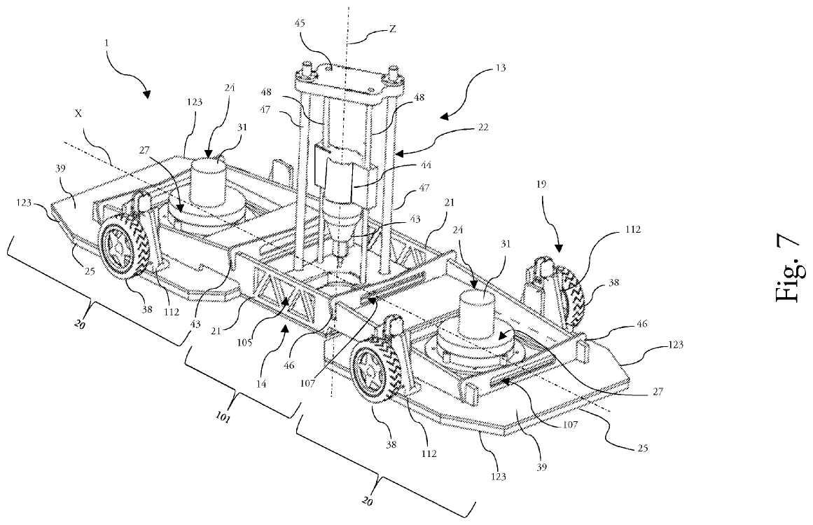

FIG. 7 is a schematic perspective view of the automated device;

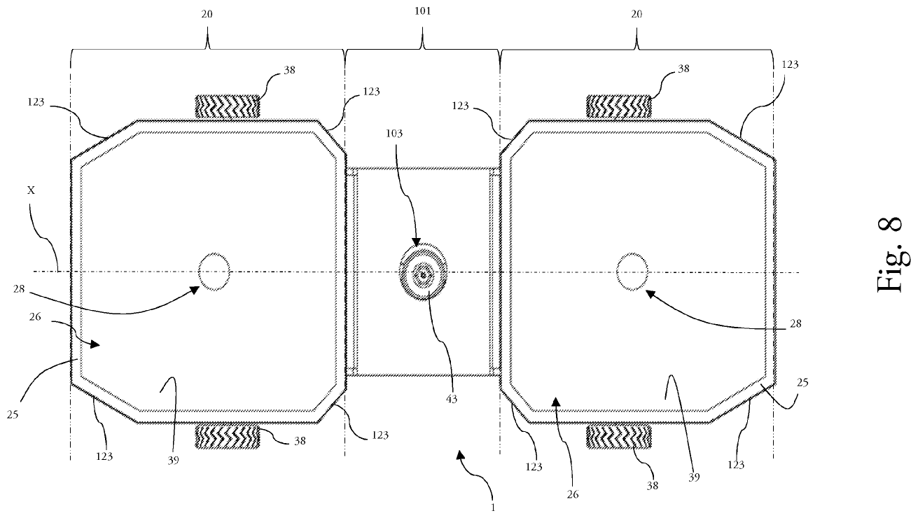

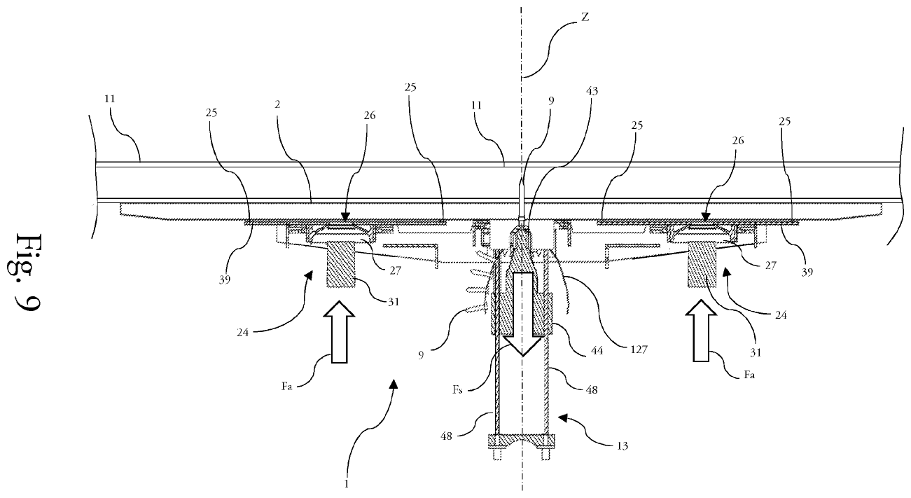

FIG. 8 schematically shows a bottom view of the automated device;

FIG. 9 is a view in longitudinal section of the automated device illustrated in abutment against a construction panel.

It should first of all be noted that, although the figures set out the invention in detail for the implementation thereof, said figures may of course serve to better define the invention if necessary. It should also be noted that the same elements are denoted by the same references throughout the figures. Finally, the term “substantially” should be understood below as meaning that the dimensions, directions and orientations mentioned in the following text take into account manufacturing and assembly tolerances.

FIG. 1 illustrates a general context of preferred application of the invention. This figure schematically shows, in an interior view, a part of a room 4 in a building. Visible in FIG. 1 are a ceiling 3 and two room walls 5, 6, respectively, of the room 4. Also shown in FIG. 1 is a direct trihedron (L, V, T) representing the three spatial directions, namely a horizontal direction L, a vertical direction V, and a transverse direction T, respectively. Also shown schematically in FIG. 1 is an opening 7 arranged in the room wall 6: the opening 7 may, for example, be intended to receive a window. The room 4 advantageously has one or more other room walls, and a floor, these not being shown in FIG. 1.

The ceiling 3 and the room walls 5, 6 each form a wall of the room 4, intended to be covered by one or more construction panels 2. In the following text, the invention will be described and illustrated in the context of a construction panel 2 intended to be attached to the wall formed by the ceiling 3, it being understood that the elements and features described for such a construction panel 2 apply to any construction panel 2 intended to be attached to one of the room walls 5, 6, which are visible in FIG. 1, or to any other wall such as a room wall or floor of the room 4. These elements and features described for the construction panel 2 also apply to any construction panel 2 intended to be attached to a support independent of a wall, as is the case for room partitioning.

According to various examples, the construction panel 2 may have a layer of plaster sandwiched between two facing sheets, thereby forming a panel known as a plasterboard sheet, or the construction panel 2 may, for example, consist of wood or of a composite material comprising wood fragments that are joined together, for example by a polymer resin.

In any event, regardless of the material chosen, the construction panel 2 is advantageously a sheet, the overall shape of which is substantially that of a rectangular parallelepiped, a length 40, partially shown in FIG. 1, and a width 41 of which are large compared with the thickness 42, which is visible in FIGS. 3 and 4. Typically, the length 40 and the width 41 of such a construction panel 2 vary from several tens of centimeters to several meters, and the thickness 42 of such a panel 2 is around a few millimeters to a few centimeters.

The construction panel 2 has a first face, or interior face, and a second face 50, or exterior face, which are substantially rectangular and mutually parallel, each of them having the abovementioned length 40 and width 41. The interior face 49 is the face of the construction panel 2 that is intended to be placed on the wall of the room 4 to which the construction panel 2 is attached: it is visible in FIGS. 3 and 4. The exterior face 50 is the face of the construction panel 2 that is intended to be visible from the interior of the room 4 and along which the automated device 1 that is the subject of the invention moves.

Advantageously, the construction panel 2 is attached to the wall by means of a support 8 that is itself for example secured to the wall. According to different embodiments, the support 8 may be metallic, it may be made of wood, or it may be formed from a composite material for example based on wood fragments and a polymer resin. Regardless of the material of which it is made, the support 8 is a rigid element that is secured to the wall, for example by screws, bolts, staples or glued thereon, or is independent of this wall.

According to different exemplary embodiments, the support 8 may be in the form of one or more rectilinear rails, for example with a square or rectangular section on a plane perpendicular to the main direction of extension thereof. Advantageously, these rails can be disposed in a grid on the wall intended to receive the construction panel, so as to jointly form a lattice that thus forms a support 8 framework for the construction panel(s). These construction panels may cover all or part of this wall, or form room partitioning as such, in the absence of a wall to be covered.

According to the exemplary embodiment illustrated more particularly in FIG. 1, the support 8 comprises a first set of rails 11 and a second set of uprights 12. The rails 11 of the first set and the uprights 12 of the second set are thus substantially perpendicular to one another. The rails 11 and the uprights 12 thus form a grid of bars forming the framework secured to the ceiling 3 or the room wall 5, 6, the construction panels 2 being intended to be fastened to said framework.

Advantageously, a distance 52, measured in the above-defined transverse direction T, between two rails 11 of the first set of rails is substantially equal to the width 41 of a construction panel 2. Of course, additional rails of the first set of rails are provided between these two rails 11 and the construction panel 2 is fastened thereto.

As shown in FIG. 1, the construction panel 2 is advantageously fastened to the rails 11 of the first set of rails, for example by a set of fastening means 9. As a result of the above, a fastening means 9, for example a screw inserted in the vicinity of one edge 15 of the construction panel 2 in the vertical direction V, passes through the construction panel 2 and into one of the rails 11. It should be noted that some fastening means 9 can be inserted into one of the uprights 12 without this having a detrimental effect on the invention.

FIG. 1 also schematically shows the automated device 1 according to the invention in a position in which, for example, this automated device 1 carries out an operation of fitting and tightening the fastening means 9 for fastening the construction panel 2 to the support 8. The automated device 1 according to the invention is illustrated more particularly in FIG. 2.

With reference to FIG. 2, the automated device 1 according to the invention comprises a frame 14 equipped with wheels 38. According to the exemplary embodiment illustrated more particularly in FIG. 2, the frame 14 has a substantially rectangular overall shape extending in a main direction of extension X, referred to as the longitudinal direction of the automated device 1 in the following text. With reference to the abovementioned main direction of extension X, a transverse direction Y of the automated device 1, perpendicular to the abovementioned main direction of extension X, and a vertical direction Z perpendicular to the plane defined by the abovementioned longitudinal direction X and the abovementioned transverse direction Y are defined, such that the directions (X, Y, Z) form a direct trihedron. With reference to this direct trihedron (X, Y, Z), the frame 14 extends substantially mainly in a plane defined by the longitudinal direction X and by the transverse direction Y.

As illustrated in FIG. 2, the frame 14 of the automated device 1 comprises a central carrying part 101 for a tool 13 and two platforms 20 arranged on either side of this tool 13, that is to say on either side of the central part 101. In other words, the automated device 1 comprises, in this order and along its axis X of extension, a first platform 20, the central part 101, and a second platform 20.

These platforms 20 each have a substantially rectangular shape, the corners of which have chamfers 123. Advantageously, this allows the automated device 1 to more easily access certain portions of the construction panels to be fastened, in particular the corners of this construction panel.

The platform 20 comprises a plate 39, at least one means 19 for setting the automated device 1 in motion, and a suction member 24. The plate 39 is provided with a passage through which the air is drawn in order to generate the vacuum. The plate 39 comprises an exterior peripheral strip where a sealing device 25 is disposed. The space between the plate 39, the construction panel and the sealing device 25 forms a vacuum chamber, the latter having a suction mouth intended to be positioned against the construction panel.

According to the example illustrated here, each of the wheels 38 is carried by a rigid structure 112, which is secured to one of the plates 39 and extends mainly in a direction perpendicular to a plane in which most of the plate 39 extends.

As shown in FIG. 2, the platforms 20 are also connected together by at least one reinforcement 21, advantageously two parallel reinforcements 21 arranged on either side of the tool 13. More particularly, these reinforcements 21 extend in two directions parallel to the axis X of extension of the frame 14. These reinforcements 21 are advantageously configured both to improve the strength of the automated device 1 and to stiffen the frame 14 as a whole. In order not to make the automated device 1 too heavy, these reinforcements 21 have cutouts 105 made for example next to the central part 101 of the frame 14. According to the example illustrated here, these cutouts 105 each have a triangular shape, but it will be understood that any other shape would be conceivable without departing from the scope of the invention. Additional reinforcements are also provided and are disposed so as to connect the reinforcements 21.

As shown in FIG. 2, the frame 14 carries four wheels 38 distributed symmetrically at the periphery of the frame 14, the four wheels 38 forming a component of a means 19 for setting the automated device 1 in motion. The four wheels 38 therefore allow the movements of the automated device 1 and the guidance thereof during these movements. More specifically, the wheels 38 allow the automated device 1 to move against the exterior face of the construction panel 2.

With reference to FIG. 2, the automated device 1 comprises the tool 13 configured to carry out at least one mechanical operation on the construction panel. According to the exemplary embodiment illustrated more particularly in FIG. 2, the tool 13 is placed in a substantially central position on the above-defined frame 14. In this particular example, this tool 13 extends mainly in a direction Z of extension perpendicular to the plane in which at least one of the plates 39 of the frame 14 extends. The tool 13 comprises at least one head 43 controlled by a motor 44, for example an electric motor. As shown in FIG. 2, this head 43 and the motor 44 are carried by a support bracket 22 formed by two columns 47 connected together by a rear block 45. More particularly, the head 43 and the motor 44 are connected to the rear block 45 of the support bracket 22 by two small columns 48.

According to the invention, the automated device 1 is capable of moving in abutment against an exterior face of a construction panel while remaining in permanent contact with this face. To this end, the automated device 1 comprises the means 19 for setting the automated device 1 in motion. This means 19 for setting in motion comprises at least one electric motor associated with one of the wheels 38, both being configured to set the automated device 1 in motion. By way of non-exclusive example, the electric motor is for example supplied with current by a domestic power supply or by an energy source installed on the frame 14, such as an electrical storage device.

According to the invention, the automated device 1, also known as an automaton, comprises a system 700 for identifying the support against which the construction panel is pressed. According to the example in FIG. 2, this identification system 700 comprises a sensor 76 disposed in situ on the frame 14 of the automated device 1. This sensor 76 is for example secured to the central part 101, in the immediate vicinity of the tool 13. The identification system 700 will be discussed in more detail with reference to FIGS. 3 and 4.

The automated device 1 also advantageously comprises a control unit 34 configured to bring about, in particular, the operation of the electric movement motor, the operation of a suction member 24, and the operation of the above-defined tool 13.

As mentioned above, the invention provides for the automated device 1 to comprise a suction member 24 configured to generate a vacuum in a chamber. According to the exemplary embodiment illustrated more particularly in FIG. 2, the automated device 1 comprises two suction members 24 disposed on either side of the tool 13 in the longitudinal direction X of the automated device 1 according to the invention.

According to one feature of the invention, the suction member 24 comprises the sealing device 25, which, together with the constituent plate 39 of the frame 14, delimit the vacuum chamber in which the pressure reduction takes place to hold the automated device 1 against the construction panel.

The suction member 24 also comprises a means 27 for reducing the pressure in the chamber, which is schematically illustrated in FIGS. 2 to 4 and forms the element that generates the vacuum in the vacuum chamber. By way of example, this pressure reducing means 27 takes the form of an impeller set in rotation by an electric motor 31, on the shaft of which the impeller is disposed.

The sealing device 25 is configured to be involved simultaneously in the pressure reduction generated by the suction member 24 and in the movements of the automated device 1 against the construction panel 2. The sealing device 25 may be a seal made of a material specifically chosen for its mechanical properties or treated so as to give it the desired mechanical properties, for example by an appropriate surface treatment or by the addition of a film of a specific material chosen for its mechanical properties. The mechanical properties more specifically desired in the context of the sealing device 25 are, in particular, friction properties, sealing having to be maintained when the automated device 1 according to the invention moves against a face of the construction panel 2.

The suction member 24 and the sealing device 25 thereof thus make it possible for the automated device 1, in all the spatial positions thereof, to move against an exterior face of a construction panel 2, in an autonomous manner, while remaining in permanent contact with the exterior face on which it moves.

This is illustrated more particularly in FIG. 1, in which the automated device 1 according to the invention is shown moving against the ceiling 3 of the room 4. The suction member 24 and the sealing device 25 thereof make it possible here to counteract the effects of gravity, which would cause the automated device 1 to fall. Similarly, the suction member 24 and the sealing device 25 thereof are configured such that the automated device 1 moves along the construction panel 2 disposed vertically against a room wall 5, 6, here again counteracting the effects of gravity, which would cause the automated device 1 to fall.

FIGS. 3 and 4 respectively illustrate, in cross section on a plane parallel to the vertical longitudinal plane (XZ) of the automated device 1 according to the invention, two embodiment variants of such an automated device 1 placed against a construction panel 2. These figures show the construction panel 2 and the above-described interior face 49 and exterior face 50 thereof. These figures also schematically illustrate a rail 11 of the support 8 to which the construction panel 2 is in this case intended to be screwed.

FIGS. 3 and 4 also show, in cross section, the frame 14, the suction members 24 and the tool 13 of the automated device 1, and also a fastening means 9 passing through the construction panel 2 and being inserted into the rail 11 of the support 8. The rail 11 of the support 8, which is shown in cross section in FIGS. 3 and 4, has a U-shaped profile, a first leg of which is pressed against the interior face 49 of the construction panel 2 and a second leg of which is in abutment against the upright 12 that can be seen in FIG. 1. The plate 39 of each platform, the pressure reducing means 27 and the sealing device 25 delimit the vacuum chamber 26.

According to one of its features, the automated device 1 according to the invention comprises the system 700 for identifying a position of the support 8 to which the construction panel 2 is attached.

According to the first embodiment variant illustrated in FIG. 3, the system 700 for identifying the support 8 comprises the sensor 76 configured to detect at least one material of which the support 8 is made. In a nonlimiting manner, the sensor 76 may be a metal sensor, a density sensor, an ultrasonic sensor and/or a magnetometer, for example a three-axis magnetometer. In such a case, the sensor may also provide an orientation of the automated device 1 according to the invention in space.

As shown in FIG. 3, the sensor 76 is advantageously placed in the immediate vicinity of the tool 13, in order to optimize the representativeness of the detection effected for the mechanical operation to be carried out by means of this tool 13. The sensor 76 is thus carried by the frame 14. This sensor 76 is in this case disposed between the two suction members 24 and has a detection face disposed in a plane passing through the plate 39 of at least one of the suction members 24. This ensures that the sensor 76 is in an ideal position for detecting the support 8, without otherwise damaging the sensor 76.

According to the second embodiment variant illustrated in FIG. 4, the invention provides for the automated device 1 according to the invention to comprise a memory unit 77 for storing a set of data relating to positions of the support 8. Such a memory unit 77 is part of the identification system 700 according to the invention. The memory unit 77 is configured, for example, to communicate with an external device 81 in which a set of positions of the support 8 is prerecorded. The external device 81 may be part of the identification system 700. According to one example, the external device 81 is a computer, a smartphone, a tablet, or any electronic means capable of delivering data relating to positions of the support 8. The external device 81 sends to the control unit 34 of the automated device 1 either a map of the support 8, or data relating to the position of the support 8, or instructions for the movement of the automated device 1 that reflect the position of the support 8.

The first embodiment variant illustrated in FIG. 3 and the second embodiment variant shown in FIG. 4 may be exclusive of one another. Alternatively, these two variants may be complementary, the automated device 1 according to the invention then comprising the sensor 76 and the memory unit 77 for storing a set of data relating to positions of the support 8.

According to one particular exemplary embodiment, the above-described control unit 34 may advantageously comprise a member 82 for determining an instantaneous position of the automated device 1 on the construction panel 2. By way of nonlimiting example, this instantaneous position may be determined with respect to a reference position, for example defined by the manual placement of the automated device 1 at an initial position against the construction panel 2. This instantaneous position may also be determined, at predefined time intervals, by an autonomous system for locating the automated device 1 with reference to one or more reference points previously defined on the wall 1 or in the room 4 in which the automated device 1 is placed.

The automated device 1 may also comprise a control module 78 configured to compare the instantaneous position of the automated device 1 on the construction panel 2 with one or more positions of the support 8, these positions having been recorded beforehand in the memory unit 77.

The invention also extends to a method for using an automated device 1, as has just been described, to carry out a mechanical operation on a construction panel 2 against which the automated device 1 is placed.

FIG. 5 schematically illustrates the execution of such a method. This method will be described here in the context of an operation for installing a construction panel 2 on a support 8, that is to say in the context of the fitting and tightening of a set of fastening means 9 for fastening the construction panel 2 to the support 8. As was indicated above, this application is not exclusive and the method according to the invention also applies to any type of mechanical operation that can be carried out by means of an appropriate tool 13 for a construction panel 2.

With reference to FIG. 5, the method according to the invention comprises at least a step 100 of moving the automated device 1 according to the invention against the exterior face of the construction panel 2, and a second step 200 of identifying the support and a third step 300 of employing the tool defined above.

According to a first implementation variant of such a method, corresponding to the first embodiment variant of the automated device 1 illustrated in FIG. 3, the step 200 of identifying the support comprises a substep 210 of detecting a material of which the support 8 is made, for example by means of the sensor as defined above.

During step 100 of moving the automated device 1, the means for setting the automated device in motion is activated, for example, by the control unit, until the sensor detects the presence of a support.

Once this detection has been carried out, the means for setting the automated device in motion is interrupted and the tool is controlled by the control unit so as to implement the intended mechanical operation. Once the mechanical operation has been carried out, the control unit controls the means for setting in motion over a distance previously recorded in the control unit. If the presence of the support is again or still detected by the sensor, a new employment of the tool can be brought about by the control unit.

According to this first variant, the invention provides for the sequences of step 100 for moving the automated device and step 300 for employing the tool to follow one another until, for example, the presence of the support is not confirmed during the substep 210 of detecting the support, or until it is not possible for the automated device to move again. A worker can then, for example, manually move the automated device into a new position on the construction panel, from which the above-described sequences can be started again.

A second variant of the method according to the invention corresponds to the second embodiment variant, illustrated in FIG. 4, of the automated device according to the invention. According to this second embodiment variant, the automated device 1 according to the invention comprises a memory unit in which a set of positions of the support is recorded. The step 200 of identifying the support then comprises a substep 220 of receiving and recording this set of positions of the support. This set thus forms a map of the position of the support, and the automated device can then move over the construction panel until it is in line with these recorded positions.

According to this second implementation variant, the method according to the invention advantageously provides for the automated device to be, for example, placed at an original position, previously recorded as reference position in the memory unit. The control unit of the automated device then causes said automated device to move to a first position of the support received by and stored in the abovementioned memory unit during substep 220. When the automated device according to the invention has reached the first abovementioned position of the support, the control unit causes the tool to carry out the desired mechanical operation. Once this mechanical operation has been carried out, the control unit causes the automated device according to the invention to move to a next position of the support, prerecorded in the memory unit.

Advantageously, the method according to the invention may comprise a step 400 of comparing an instantaneous position of the automated device according to the invention against the construction panel with a position of the support. According to the invention, the above-defined control unit then controls the movements of the automated device 1 depending on the result of the comparison between the position, at a given instant, of the automated device according to the invention against the construction panel, and the position of the support. The instantaneous position of the automated device on the construction panel is then, for example, determined by the member for determining the position of the automated device against the construction panel, as described with reference to FIG. 4.

As has just been described, the invention makes it possible, by virtue of the means that it employs, to carry out one or more repetitive mechanical operations on a construction panel in a reliable and reproducible manner. It thus clearly achieves the aims set therefor.

Referring now to FIG. 6, the automated device 1 according to the invention in situ can be seen. The latter travels over a construction panel 2 covering a ceiling 3 situated in a room schematically depicted in FIG. 6 by two wall panels 5, 6 inclined at 90° with respect to a horizontal plane, this horizontal plane being parallel to a main plane of extension of the ceiling 3. One of the wall panels is interrupted by a window 7. The other is not. This siting is not limiting, and it may be possible for example to dispose the automated device 1 on a construction panel 2 that is used to form or covers one or the other of the wall panels 5, 6.

The construction panel 2 is thus secured to the ceiling 3 by way of a framework 80, which corresponds to the support 8 described in FIGS. 1 to 5. More specifically, a plurality of construction panels 2 are secured to this ceiling by way of this framework 80.

According to the example illustrated in FIG. 6, one of these construction panels 2 is in the process of being fastened to this ceiling 3, meaning that the automated device 1 according to the invention is fastening the construction panel 2 to the framework 80, which has itself been fastened to the ceiling 3 beforehand. It will be understood that once the construction panel 2 has been secured to the framework 80, an internal space 32 is created between the ceiling 3 and the construction panel 2. Advantageously, a sound absorbing and/or thermally insulating element can be positioned in this internal space 32. Such a sound absorbing element can occupy all or part of a volume of the internal space 32.

This framework 80 may for example consist of a metallic framework comprising rails 11 mounted on uprights 12 perpendicular to these rails 11. These rails 11 each form a zone for supporting and fastening a construction panel 2. In other words, each construction panel 2 comprises a first edge 15 intended to be fastened to a first rail and a second edge 16 intended to be fastened to a second rail. Provision could also be made for each construction panel 2 to also be fastened to two central rails, that is to say a third rail parallel to the first rail and to the second rail and a fourth rail that is likewise parallel to this first rail and to this second rail. Advantageously, the automated device 1 according to the invention is configured to fasten each construction panel 2 to each of these rails 11.

Alternatively, this framework 80 can be made of wood. It will be understood that any other material that is compatible with the invention is conceivable for producing this framework 80 without departing from the scope of the invention.

As shown, the construction panel 2 is secured to the framework 80 by virtue of fastening means 9. It will be understood that each of these fastening means 9 passes through the construction panel 2 in order to be driven into one of the rails 11 of the framework 80 and thus ensure this securing. For example, these fastening means 9 may be screws, nails or staples. Two rectilinear rows of fastening means 9 are illustrated in FIG. 1, at least the fastening means 9 of one and the same row being fastened to one and the same rail. Advantageously, two adjacent construction panels 2 are fastened to one and the same rail. Alternatively, provision could be made for each construction panel 2 to be fastened to its own rails.

It will be understood from FIG. 6 that these fastening means 9 are fitted by the automated device 1, which moves parallel to the rail in question. This automated device 1 and the manner of operation thereof will now be described in more detail with reference to FIGS. 7 to 9.

FIG. 7 schematically illustrates the automated device 1 according to the invention, this FIG. 7 being a perspective view of this automated device 1. FIG. 8 shows a bottom view of the automated device 1 according to the invention. Finally, FIG. 9 is a view in cross section of the automated device 1. With reference to FIG. 6, this cross section shown in FIG. 9 is made on a plane perpendicular to the main plane of extension of the ceiling 3 over which the automated device 1 moves, this plane being referenced AA in FIG. 6.

The automated device 1 comprises a frame 14, which extends mainly along an axis X of extension and to which there are fastened at least one means 19 for setting the automated device 1 in motion, a fastening tool 13 configured to fasten a construction panel to a framework as described with reference to FIG. 6, and at least one suction member 24, advantageously two suction members 24, configured to allow the automated device 1 to remain in abutment against the construction panel to be fastened regardless of the inclination of this construction panel. As shown, the fastening tool 13 extends mainly in a direction Z of extension at least perpendicular to the axis X of extension of the frame 14.

The exemplary embodiment of the automated device 1 described in FIGS. 6 to 9 shows a fastening tool referenced 13, but this fastening tool is given only by way of example and could be replaced by a tool for cutting the construction panel or a tool for sanding the construction panel. To simplify the description, the automated device 1 in FIGS. 6 to 9 is described in combination with the fastening member 13 for fastening the construction panel, but it will be understood that this detailed description applies to any tool configured to carry out a mechanical operation on or in the construction panel, for example the cutting tool or sanding tool mentioned above.

According to an example illustrated in FIGS. 7 to 9, the means 19 for setting in motion comprises a plurality of wheels 38, in this instance four wheels 38, each of these wheels 38 being controlled by its own electric drive motor—not shown in these figures. Alternatively, all of the wheels 38 are controlled by a single electric drive motor. These wheels 38 may for example be textured so as to improve their grip on the construction panel being fastened and thus improve the traction capacity of these wheels 38. It will be noted, however, that these wheels 38, whether or not they are textured, only serve to move the automated device 1, meaning that this automated device 1 is only held in abutment against the construction panel by virtue of the suction members 24 described below.

As illustrated for example in FIG. 7, the frame 14 of the automated device 1 comprises a central carrying part 101 for the fastening tool 13 and two lateral platforms 20 arranged on either side of this fastening tool 13, that is to say on either side of the central part 101. In other words, the automated device 1 comprises, in this order and along its axis X of extension, a lateral platform 20, the central part 101, and another lateral platform 20.

These lateral platforms 20 each comprise at least one plate 39 of substantially rectangular shape, the corners of which have chamfers 123. Advantageously, this allows the automated device 1 to more easily access certain portions of the construction panels to be fastened, in particular the corners of these construction panels.

Each of the lateral platforms 20 also carries one of the suction members 24 of the automated device 1 and two of the four wheels 38 forming the means 19 for setting the automated device 1 in motion. In other words, these wheels 38 are distributed in pairs on either side of each suction member 24. According to the example illustrated here, each of the wheels 38 is carried by a rigid structure 112, which is secured to one of the plates 39 and extends mainly in a direction perpendicular to a plane in which the plates 39 of the frame 14 extend, that is to say in a direction parallel to the direction Y of extension of the fastening tool 13. For example, these rigid structures 112 may each have a triangular shape, a median of which extends parallel to the direction Y of extension of the fastening tool 13.

As shown in FIG. 7, the lateral platforms 20 are also connected together by at least one reinforcement 21, advantageously two parallel reinforcements 21 arranged on either side of the fastening tool 13. More particularly, these reinforcements 21 extend in two directions parallel to the axis X of extension of the frame 14. These reinforcements 21 are advantageously configured both to improve the strength of the automated device 1 and to stiffen the frame 14 as a whole. In order not to make the automated device 1 too heavy, these reinforcements 21 have cutouts 105 made for example next to the central part 101 of the frame 14. According to the example illustrated here, these cutouts 105 each have a triangular shape, but it will be understood that any other shape would be conceivable without departing from the scope of the invention.

It is also noted that two pairs of additional reinforcements 40 can be arranged on the frame 14, and more particularly between the two reinforcements 21 connecting the lateral platforms 20. In other words, these pairs of additional reinforcements 40 extend in directions perpendicular to the axis X of extension of the frame 14 and to the direction Y of extension of the fastening tool 13. These pairs of additional reinforcements 40 advantageously make it possible to connect the two reinforcements 21 together and are thus likewise involved in stiffening the frame 14 and improving the mechanical strength of the automated device 1. In the example illustrated, one pair of additional reinforcements 40 is arranged next to each lateral platform 20. More specifically, the additional reinforcements 40 are distributed in pairs around each suction member 24. It will be understood that each suction member 24 is thus framed by the two reinforcements 21 and a pair of additional reinforcements 40. As before, the additional reinforcements 40 comprise at least one material removal 107 such that these additional reinforcements 40 do not unnecessarily add weight to the automated device 1. According to the example illustrated here, these material removals 107 are in the form of slots that extend perpendicularly to the axis X of extension of the frame 14 and to the direction Y of extension of the fastening tool 13. The reinforcement structure set out above is given by way of example and any other structure that connects the suction members 24 to the fastening tool 13 could enter into the scope of the present invention.

The fastening tool 13 is for its part configured to employ the fastening means 9 mentioned above. As mentioned above, the fastening means 9 employed by the fastening tool 13 may be nails, screws or staples. Thus, according to a first exemplary embodiment, the fastening tool 13 is a screwdriver, according to a second exemplary embodiment, this fastening tool is a nail gun, and finally, according to a third exemplary embodiment, this fastening tool is a stapler. In the present description, the term “fastening means” is thus used to denote either a nail, a screw or a staple and the term “fastening tool” for its part denotes any one of the fastening tools that have just been cited.

Overall, this fastening tool 13 extends mainly in the direction Y of extension perpendicular to the plane in which the plates 39 of the frame 14 extend. The fastening tool 13 comprises at least one fastening head 43 controlled by a motor 44, for example an electric motor. As shown in FIG. 7, this fastening head 43 and the motor 44 are carried by a support bracket 22 formed by two columns 47 connected together by a rear block 45. More particularly, the fastening head 43 and the motor 44 are connected to the rear block 45 of the support bracket 22 by two small columns 48, which extend parallel to the direction Y of extension of the fastening tool 13.

As mentioned above, the automated device 1 according to the invention advantageously comprises two suction members 24. According to the example illustrated in FIGS. 7 to 9, these suction members 24 are identical and the description that will be given of one of them is transferable to the other. In the same way, the references borne by one of these suction members 24 in one of FIGS. 6 to 9 is transferable to the other suction member 24 in these figures.

Each suction member 24 thus comprises the plate 39 of the lateral platform 20 by which it is carried and a sealing device 25. This plate 39 and this sealing device 25 delimit a vacuum chamber 26, this sealing device 25, this vacuum chamber 26 and this plate 39 being illustrated for example in FIGS. 3 and/or 4.

Each suction member 24 also comprises a means 27 for reducing the pressure in the vacuum chamber 26, said means being controlled by a motor 31, for example an electric motor. This pressure reducing means 27 is thus configured to draw out the air present between the automated device 1 and the construction panel against which it is in abutment, so as to create a vacuum in the vacuum chamber 26 delimited by the sealing device 25 and the plate 39 and thus to keep the automated device 1 in abutment against the construction panel that it is fastening, regardless of the orientation of the latter. In particular, this vacuum is sufficiently great to keep the automated device 1 against a ceiling, as illustrated for example in FIG. 6, or against a room wall. For example, the pressure reducing means 27 is an impeller.

As shown in FIG. 8, each plate 39 is thus provided with an orifice 28 through which the air is drawn out in order to generate the vacuum in the vacuum chamber 26. The plate 39 comprises an exterior peripheral strip along which the sealing device 25 is disposed. The space between the plate 39, the construction panel and the sealing device 25 forms the vacuum chamber 26. The longitudinal axis X of the automated device 1 passes through the fastening tool 13 and through the orifice 28 in each plate 39. Advantageously, these plates 39 are made of a flexible and/or deformable material. Thus, when the pressure in the vacuum chambers 26 of the suction members 24 is reduced, these plates 39 are configured to deform at least partially such that they come into abutment against the construction panel against which the automated device 1 moves. For example, these plates 39 can be made using wooden boards with an average thickness of about 3 mm, this thickness being measured parallel to the direction Y of extension of the fastening tool 13 between two opposite faces of the plate 39 in question. It will be understood that these plates 39 can be made from any other material provided that this material exhibits sufficient deformability to allow these plates 39 to come into abutment against the construction panel.

The central part 101 of the frame 14 also comprises an opening 103, visible for example in FIG. 8, through which the fastening head 43 of the fastening tool is able to pass. It will be understood that it is through this opening 103 that the fastening tool positions one of the fastening means on the construction panel. In other words, this opening 103 allows the fastening tool, and more particularly the fastening head 43 of this fastening tool, to access the construction panel to be fastened.

This fastening tool 13 advantageously comprises an automatic system for loading the fastening means 9. According to an example illustrated in FIG. 9, the automatic loading system is a system of screws in a string. In other words, the automated device 1 thus comprises a string 127 of screws that forms a reserve of screws, such that once in operation, no human intervention is necessary in order for the automated device 1 to fit the fastener. The steps of a fastening method implemented by the automated device 1 according to the invention will be described in greater detail below.

It will be understood from the above description that, in order to operate, the automated device 1 according to the invention has to be supplied with electricity. Thus, according to one embodiment of the present invention, the automated device 1 is connected, for example via an electric wire, to an external power supply. According to another embodiment, the automated device 1 comprises an electrical storage device, which provides it with the electrical energy it needs. In other words, and according to the first embodiment, the automated device 1 is supplied by an energy source external to the frame 14 and, according to the other embodiment, this automated device 1 is supplied by an energy source internal to this frame, that is to say carried thereby. When the energy source is external, the movements of the automated device are only limited by the dimensions of the electric wire connecting it to this external energy source, whereas when the automated device is supplied by an internal energy source, its operating time is limited by the storage capacity of the electrical storage device that provides this supply.

The automated device 1 according to the invention is also configured to implement a method for fastening a construction panel, a method for cutting a construction panel or a method for sanding a construction panel.

FIG. 9 is a schematic depiction, in cross section, of the automated device 1 as shown in FIG. 6, that is to say according to a step in this method. This cross section is made on a plane which passes through the fastening tool 13 and in which the axis X of extension of the frame 14 and the direction Y of extension of the fastening tool 13 are inscribed.

Such a method will now be described in detail. Firstly, a plurality of fastening points are defined. For example, a map of the fastening points may be recorded in this automated device 1. Alternatively, the automated device according to the invention may comprise at least one means for detecting these fastening points, that is to say a means for detecting the position of the rails 11 of the framework to which the construction panel in question is intended to be fastened. The worker using this automated device loads the automated device 1 with the fastening means 9 he deems to be the most suitable, in particular depending on the type of materials used for the construction panel 2 and the rails 11 of the framework to which this construction panel 2 is intended to be fastened. The worker can then place the automated device 1 on the construction panel 2 to be fastened and start up this automated device 1. It will be understood that the starting-up of the automated device is preceded by manual pre-fastening of the construction panel 2. In other words, the worker fastens some of the fastening means 9 before using the automated device 1. For example, he can position four fastening means at the four corners of the construction panel 2 in question.

When the automated device is started up, the suction member(s) 24 is/are started up so that they create a vacuum in the vacuum chambers 26. As is particularly visible in FIG. 9, this vacuum created in the vacuum chambers 26 results in the plates 39 being pressed against the construction panel 2 being fastened. The wheels—which are not visible in FIG. 9—are then set in rotation so as to move the automated device 1 to a first fastening point. More precisely, this automated device 1 then moves until the fastening tool 13 is positioned next to this first fastening point, that is to say next to a first rail 11 of the framework to which the construction panel 2 in question needs to be fastened.

For its part, the fastening tool 13 is configured to load a fastening means 9 in the fastening tool 13, for example by virtue of the automatic loading system with which it is equipped. Once next to the first rail 11, the fastening tool 13 is configured to employ the fastening means 9 thus loaded so as to fasten the construction panel 2. By way of example, the fastening head 43 of the fastening tool 13 is set in rotation by the motor 44 of the fastening tool 13. Next, this fastening head 43 slides along the small columns 48 of the fastening tool 13, thereby applying a force to the fastening means 9, for example a screw in this case.

As illustrated in FIG. 9, once employed, the fastening means 9 then passes both through the construction panel 2 and through the first rail 11, such that the two elements are now secured. Once this fastening means 9 is in position, the fastening head 43 of the fastening tool 13 returns to its initial position, where a new fastening means 9 is loaded in the fastening tool 13. Simultaneously or non-simultaneously with this loading of the fastening tool 13, the wheels are set in rotation again so as to move the automated device 1 to a next fastening point, more precisely so as to move the automated device 1 until the fastening tool 13 is positioned either next to another portion of the first rail 11 or next to a second rail 11 at a distance from the first rail 11. On one and the same rail 11, provision could be made for example for two successive fastening means to be spaced apart by about 30o mm.

It will be understood that the suction members 24 have to create a vacuum in the vacuum chambers 26 that is sufficiently great to counteract a force Fs exerted by the fastening tool 13 when the latter employs the fastening means 9. In other words, the suction members 24 each generate a first force Fa parallel to the direction Y of extension of the fastening tool 13, the sum of these first forces Fa generated by the suction members 24 needing to be greater, in terms of absolute value, than a second force Fs generated by the fastening tool 13 when the latter employs one of the fastening means, this second force Fs being exerted in a direction parallel to the direction Y of extension of the fastening tool 13 and in the opposite direction to the direction in which the first forces Fa are exerted.

The present invention thus proposes an autonomous robot for fastening a construction panel regardless of the inclination thereof with respect to a horizontal plane. Advantageously, this robot thus makes it possible both to reduce the time usually required for workers to carry out such fastening and to considerably improve the working conditions of these workers.

The invention is not intended to be limited to the means and configurations exclusively described and illustrated, however, but also applies to any equivalent means or configurations and to any combination of such means or configurations. In particular, while the invention has been described and illustrated in the context of a mechanical operation of the type involving screwing the construction panel to its support, it applies to any type of mechanical operation to be carried out on such a panel, regardless of kind, such an operation being, in a nonlimiting manner, fastening the construction panel or cutting or sanding said construction panel. Similarly, while the invention has been described here in terms of its application to a substantially parallelepipedal construction panel, it goes without saying that it applies to any shape and/or size of construction panel.

1. An automated device configured to move in abutment against a construction panel, the automated device comprising a carrying frame for a tool configured to carry out at least one mechanical operation on the construction panel when attached to a support, chosen from an operation of fastening the construction panel to the support, an operation of cutting the construction panel or an operation of sanding the construction panel, the automated device comprising at least one suction member configured to hold the automated device against the construction panel and at least one means for setting the automated device in motion along the construction panel, wherein the automated device comprises at least one control unit configured to control at least the means for setting the automated device in motion depending on at least one item of data relating to the position of the support of the construction panel.

2. The automated device as claimed in claim 1, wherein the control unit is configured to communicate with an identification system for identifying the position of the support.

3. The automated device as claimed in claim 2, which comprises the identification system.

4. The automated device as claimed in claim 3, wherein the identification system comprises at least one sensor configured to detect a material forming the support.

5. The automated device as claimed in claim 4, wherein the identification system comprises at least one metal sensor.

6. The automated device as claimed in claim 4, wherein the identification system comprises at least one sensor for sensing the density of the material forming the support.

7. The automated device as claimed in claim 4, wherein the identification system comprises at least one magnetometer.

8. The automated device as claimed in claim 1, wherein the suction member comprises at least one sealing device and a constituent plate of the frame, which delimit a vacuum chamber.

9. The automated device as claimed in claim 8, wherein the sealing device is configured to be involved simultaneously in a pressure reduction effected by the suction member and in setting of the automated device in motion.

10. The automated device as claimed in claim 1, wherein the control unit is configured to control the tool.

11. The automated device as claimed in claim 1, wherein the control unit is configured to control the suction member.

12. The automated device as claimed in claim 1, further comprising a memory unit for storing a set of positions of the support.

13. The automated device as claimed in claim 12, further comprising a control module configured to compare an instantaneous position of the automated device on the construction panel with at least one position of the support stored in the memory unit.

14. An assembly comprising an automated device as claimed in claim 1 and an identification system remote from the automated device, the control unit of the automated device communicating with the identification system to receive the item of data relating to the position of a support of the construction panel.

15. A method for carrying out a mechanical operation on a construction panel by an automated device as claimed in claim 1, comprising:
a step of moving the automated device,
a step of identifying a support of the construction panel,
a step of employing the tool to carry out the mechanical operation on the construction panel, the mechanical operation being an operation of fastening the construction panel to the support, an operation of cutting the construction panel or an operation of sanding the construction panel.

16. The method as claimed in claim 15, wherein the step of identifying a support comprises a sub-step of detecting a material of which the support is made.

17. The method as claimed in claim 15, wherein the step of identifying a support comprises a sub-step of receiving and recording a set of positions of the support.

18. The method as claimed in claim 17, further comprising a step of comparing an instantaneous position of the automated device on the construction panel with said set of positions of the support.
